(19) United States
(12) Patent Application Publication
(10) Pub. No.: US 2012/0189873 A1
(43) Pub. Date: Jul. 26, 2012

(54) BATTERY PACK

(76) Inventor: Sanghun Park, Yongin-si (KR)

(21) Appl. No.: 13/111,816

(22) Filed: May 19, 2011

(30) Foreign Application Priority Data
Jan. 20, 2011 (KR) 10-2011-0005777

(51) Int. Cl. H01M 10/42

(52) U.S. Cl. 429/7

(57) ABSTRACT

A battery pack includes a battery cell; a lower case having an opening and a space housing the battery cell; an upper case coupled to the opening of the lower case and having a first coupling hole formed therein; a first lead tab having opposing sides coupled to the upper case, a central region between the opposing sides contacting an interior-facing surface of the upper case and having a second coupling hole, and an intermediate region between each of the opposing sides and the central region, the intermediate region being spaced from the interior-facing surface of the upper case; and a coupling unit coupling the first lead tab to the interior-facing surface of the upper case and penetrating the first coupling hole and the second coupling hole.

### CROSS-REFERENCE TO RELATED APPLICATION

This application claims priority to and the benefit of Korean Patent Application No. 10-2011-0005777, filed on Jan. 20, 2011, the entire content of which is incorporated herein by reference.

### BACKGROUND

1. Field

Aspects of the present invention relate to a battery pack.

2. Description of the Related Art

A battery pack typically includes a battery cell, a protection circuit module (PCM) that controls charging and discharging of the battery cell, and a lead tab that connects a plurality of battery cells in series or in parallel and electrically connects the battery cell and the PCM.

Connection between battery cells themselves or between a battery cell and a PCM is achieved through welding of a lead tab. The welding may include resistance welding using resistance heat through current or projection welding. However, the current or heat generated in the course of performing the welding may cause inferiority to a battery cell.

### SUMMARY

Embodiments of the present invention provide a battery pack which mechanically connects a lead tab used in connection between battery cells or connection between a protection circuit module (PCM) and a battery cell.

According to an embodiment of the present invention, a battery pack is provided including a battery cell; a lower case having an opening and a space housing the battery cell; an upper case coupled to the opening of the lower case and having a first coupling hole formed therein; a first lead tab having opposing sides coupled to the upper case, a central region between the opposing sides contacting an interior-facing surface of the upper case and having a second coupling hole, and an intermediate region between each of the opposing sides and the central region, the intermediate region being spaced from the interior-facing surface of the upper case; and a coupling unit coupling the first lead tab to the interior-facing surface of the upper case and penetrating the first coupling hole and the second coupling hole.

In one embodiment, the battery pack also includes a second lead tab contacting an end of the battery cell adjacent a surface of the lower case generally opposite to the opening and being exposed from the lower case. Further, the battery pack may also include a third lead tab positioned on an exterior-facing surface of the upper case generally opposite to the interior facing surface and contacting the coupling unit; and a protection circuit module coupled to the second lead tab and the third lead tab.

In one embodiment, the third lead tab has a third coupling hole generally corresponding to the second coupling hole, and wherein the coupling unit penetrates the first coupling hole, the second coupling hole and the third coupling hole so that the central region of the first lead tab fixedly contacts the bottom surface of the upper case. Additionally, fixing holes may be formed at opposing sides of the protection circuit module, and wherein the first lead tab and the second lead tab are coupled to the fixing holes.

In one embodiment, the upper case includes a protruding part formed on the interior-facing surface with the first coupling hole located within a periphery of the protruding part. Specifically, the protruding part may extend in a direction generally perpendicular to a lengthwise direction of the first lead tab. Further, in one embodiment, the first lead tab includes a stamping part generally corresponding to the protruding part and being coupled to the protruding part. In one embodiment, the coupling unit includes a blind rivet, a rivet, or a bolt and a nut.

In the battery pack according to exemplary embodiments of the present invention, mechanical connection of a lead tab used in connection between battery cells or connection between a protection circuit module (PCM) and a battery cell can enhance the durability of the battery pack.

Additional aspects of the invention will be set forth in part in the description which follows.

### BRIEF DESCRIPTION OF THE DRAWINGS

The objects, features and advantages of the present invention will be more apparent from the following detailed description in conjunction with the accompanying drawings, in which:

FIG. 1A is a perspective view of a battery pack according to an embodiment of the present invention;

FIG. 1B is a cross-sectional view illustrating the inside of the battery pack, taken along the line A-A° of FIG. 1A;

FIG. 2 is a cross-sectional view of a secondary battery forming the battery pack shown in FIG. 1A; and

FIGS. 3A to 3C are perspective views schematically illustrating a process of coupling a first lead tab and a coupling unit in the battery pack shown in FIG. 1A.

### DETAILED DESCRIPTION

Hereinafter, embodiments of the present invention will be described in detail with reference to the accompanying drawings.

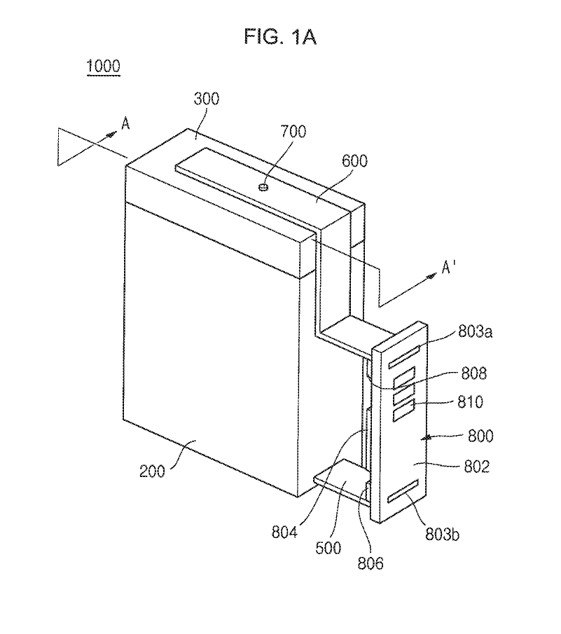

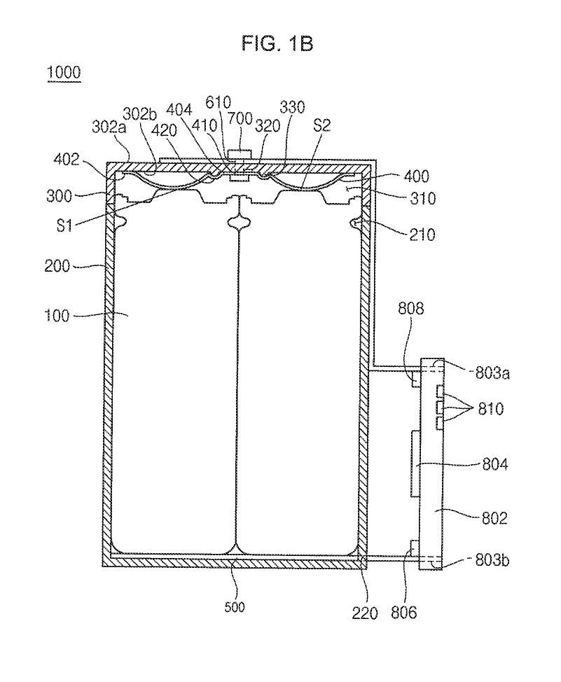

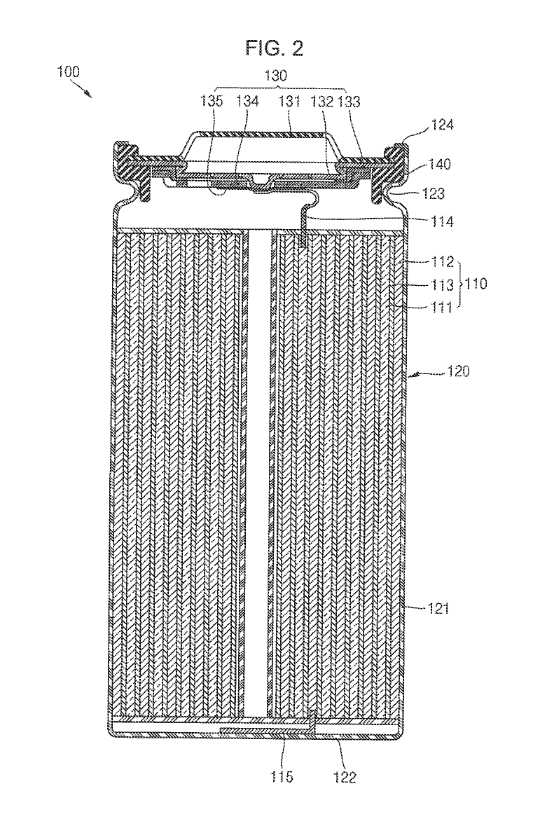

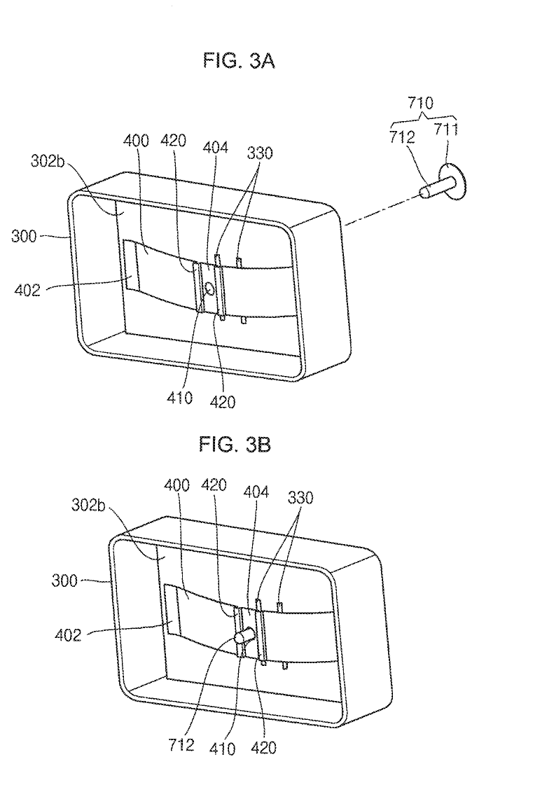

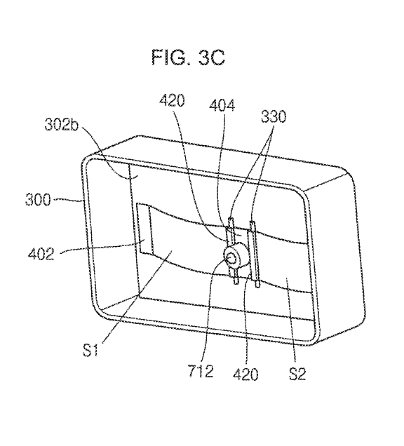

FIG. 1A is a perspective view of a battery pack according to an embodiment of the present invention, FIG. 18 is a cross-sectional view illustrating the inside of the battery pack, taken along the line A-A′ of FIG. 1A, FIG. 2 is a cross-sectional view of a secondary battery forming the battery pack shown in FIG. 1A, and FIGS. 3A to 3C are perspective views schematically illustrating a process of coupling a first lead tab and a coupling unit in the battery pack shown in FIG. 1A.

Referring to FIGS. 1A to 2, the battery pack 1000 includes a battery cell 100, a lower case 200, an upper case 300, a first lead tab 400, a second lead tab 500, a third lead tab 600, a coupling unit 700, and a protection circuit module (PCM) 800.

The battery cell 100 is housed in the lower case 200 and the upper case 300. An upper end of the battery cell 100 is electrically connected to a first lead tab 400 and a bottom end of the battery cell 100 is electrically connected to a second lead tab 500. The third lead tab 600 is electrically connected to the first lead tab 400 by a coupling unit 700 with the upper case 300 located therebetween. The PCM 800 is connected to the second lead tab 500 and the third lead tab 600 to control charging and discharging of the battery cell 100.

The battery cell 100 may have a cylindrical shape or a prismatic shape, and the invention will now be described with regard to a cylindrical battery cell by way of example.

The battery cell 100 may include an electrode assembly 110, a can 120 housing the electrode assembly 110, a cap assembly 130 inserted into an opening formed at a top end of the can 120, and a gasket 140 installed on the internal surface of the top opening of the can 120.

The electrode assembly 110 may include a positive electrode plate 111, a negative electrode plate 112 and a separator 113.

The positive electrode plate 111 may be formed by coating a positive electrode active material layer having a mixture of a positive electrode active material, a conductive material and a binder on a positive electrode collector made of a conductive metal. A positive electrode uncoated portion is formed at opposing ends of the positive electrode plate 111 in the positive electrode collector without the positive electrode active material layer, and a positive electrode tab 114 is welded to one side of the positive electrode uncoated portion.

The negative electrode plate 112 is formed by coating a negative electrode active material layer having a mixture of a negative electrode active material, a conductive material and a binder on a negative electrode collector made of a conductive metal. A negative electrode uncoated portion is formed at opposing ends of the negative electrode plate 112 of the negative electrode collector without the negative electrode active material layer, and a negative electrode tab 1151 is welded to one side of the negative electrode uncoated portion.

The separator 113 is located between the positive electrode plate 111 and the negative electrode plate 112 and may extend to surround the outer peripheral surface of the electrode assembly 110. The separator 113 prevents the positive electrode plate 111 and the negative electrode plate 112 from being shorted, and is made of a porous polymer to allow lithium ions to pass therethrough.

The can 120 includes a side surface plate 121 shaped of a cylinder having a space to house the electrode assembly 110, and a bottom surface plate 122 sealing the bottom of the side surface plate 121. The can 120 is generally made of a conductive metal such as aluminum or an aluminum alloy. In addition, the can 120 may be formed by a deep drawing process. A beading part 123 is formed at an upper portion of the can 120 to prevent the electrode assembly 110 from moving. In addition, a clamping part 124 for fixing the cap assembly 130 is formed at the uppermost portion of the can 120.

The cap assembly 130 includes a cap-up 131, a safety vent 132 installed under the cap-up 131, a cap-down 134 installed under the safety vent 132, an insulator 133 located between the safety vent 132 and the cap-down 134, and a sub-plate 135 fixed on the bottom surface of the cap-down 134 to be electrically connected to the positive electrode tab 114.

The cap-up 131 is electrically connected to the electrode assembly 110 and transmits the current generated from the electrode assembly 110 to the outside. When an abnormal internal pressure is generated in the can 132, the safety vent 132 releases the internal gas of the can 120 while shutting down the current. The insulator 133 is made of an insulating material and insulates the safety vent 132 from the cap-down 134. The cap-down 134 is electrically connected to the electrode assembly 110 through the positive electrode tab 114. The sub-plate 135 electrically connects the positive electrode tab 114 to the safety vent 132. When the internal pressure of the can 132 is increased, the safety vent 132 may be ruptured so that the sub-plate 135 is electrically disconnected from the safety vent 132.

The gasket 140 is installed at the top opening of the can 120. In other words, the gasket 140 is closely adhered between the cap-up 131, the outer periphery of the safety vent 132, and the top opening of the can 120 and seals the can 120.

The lower case 200 is formed in a rectangular box shape and has a receiving space 210 formed therein and an opening at its top portion. In addition, the lower case 200 has a cutting portion 220 formed at its bottom surface. One or more of the battery cell 100 are received in the receiving space 210. In the following description, the invention will be described with regard to a case where two battery cells 100 are received in receiving space 210 of the lower case 200 and the two battery cells 100 are connected in parallel to each other although it will be appreciated that the present invention could include more or fewer battery cells.

The upper case 300 is formed in a rectangular box shape and has a receiving space 310 formed therein and an opening at its bottom portion. The upper case 300 is coupled to the lower case 200 at the top portion of the lower case 200 and seals the opening of the lower case 200.

However, the shape of the upper case 300 is not limited to the rectangular box shape. The upper case 300 may take any shape as long as it is configured to receive the battery cell 100 by sealing the receiving space 210 of the lower case 200, that is, as long as it is configured such that the battery cell 100 is surrounded by the lower case 200 and the upper case 300.

In addition, a first coupling hole 320 penetrating a top surface 302a and a bottom surface 302b of the upper case 300 is formed at the center of the upper case 300. A protruding part 330 extending in a direction generally perpendicular to a lengthwise direction of the first lead tab 400 is formed on the bottom surface 302b of the upper case 300 with the first coupling hole 320 located therebetween.

The first lead tab 400 has opposing sides 402 adhered to opposing sides of the bottom surface 302b of the upper case 300 using an adhesive, and a central region 404 fixedly contacting the bottom surface 302b of the upper case 300 using the coupling unit 700. The coupling unit 700 will later be described in more detail.

Intermediate regions between each of the opposing sides 402 and the central region 404, which are referred to as separating parts S1 and S2, hereinafter, are separated from or spaced from the bottom surface 302b of the upper case 300. In other words, the first lead tab 400 is substantially ‘w’ shaped.

In addition, a second coupling hole 410 generally corresponding to the first coupling hole 320 is formed at the central region 404 of the first lead tab 400. Further, a stamping part 420 located and shaped to generally correspond to the protruding part 330 is formed in the first lead tab 400 with the second coupling hole 410 located therebetween or within the periphery of the stamping part. The protruding part 330 is housed in the stamping part 420 so that the stamping part 420 and the protruding part 330 are coupled to each other.

The separating parts S1 and S2 contact the top surface of the battery cell 100 to be electrically connected thereto. Because the battery cell 100 contacting the separating parts S1 and S2 push or bias the separating parts S1 and S2 toward the bottom surface 302b of the upper case 300 and because the separating parts S1 and S2 have elasticity due to their materials and shapes, a biasing force pushing the battery cell 100 downward (i.e., toward the bottom surface plate 122) is generated.

The second lead tab 500 is plate-shaped and is positioned under the receiving space 210 of the lower case 200. The top surface of the second lead tab 500 contacts the bottom surface of the battery cell 100 to be electrically connected thereto and the bottom surface of the second lead tab 500 contacts the inner bottom surface of the lower case 200. A portion (a second end) of the second lead tab 500 is exposed to the outside of the lower case 200 through the cutting portion 220 of the lower case 200.

The third lead tab 600 is plate-shaped and is bent in a ‘ [symbol] ’ or a ‘ [symbol] ’ shape (i.e., the third lead tab is substantially L-shaped). One side (for example, the left side) of the third lead tab 600 is positioned on the top surface 302a of the upper case 300 and the other side (for example, the right side) of the third lead tab 600 is positioned perpendicular to the right side of the lower case 200.

In addition, the third lead tab 600 has a third coupling hole 610 corresponding to the first coupling hole 320 formed in the upper case 300.

The coupling unit 700 is made of a conductive material and contacts the first lead tab 400 and the third lead tab 600 while penetrating the first coupling hole 320, the second coupling hole 410 and the third coupling hole 610. In other words, the first lead tab 400 and the third lead tab 600 are electrically connected by the coupling unit 700. In addition, the coupling unit 700 pulls the central region 404 of the first lead tab 400 toward the bottom surface 302b of the upper case 300, thereby fixedly contacting (coupling) the central region 404 of the first lead tab 400 on the bottom surface 302b of the upper case 300.

The coupling unit 700 may be a conductive blind rivet, a rivet, or a bolt and a nut, but is not limited thereto.

The PCM 800 controls charging and discharging of the battery cell 100 and includes a circuit board 802, one or more electronic parts 804 installed on one surface of the circuit board 802, electrode leads 806 and 808 having different polarities, installed on the same surface as the one or more electronic parts 804 and electrically connected to the battery cell 100, and a plurality of external terminals 810 installed on a surface opposite to the surface on which the electrode leads 806 and 808 are installed.

The circuit board 802 is plate-shaped (i.e., it is generally flat) and has fixing holes 803a and 803b formed in the left and right sides thereof. The fixing hole 803a is formed to generally correspond to a second end of the third lead tab 600 and is coupled to a second end of the third lead tab 600 in an interference fit manner. The fixing hole 803b is formed to generally correspond to a second end of the second lead tab 500 and is coupled to the other end of the second lead tab 600 in an interference fit manner.

The electronic parts 804 are installed on the surface of the circuit board 802 facing the lower case 200. The electronic parts 804 may include charge and discharge elements.

The electrode leads 806 and 808 are positioned on the surface of the circuit board 802, which is the same as the surface on which the electronic parts 804 are installed. The electrode leads 806 and 808 are electrically connected to the second lead tab 500 and the third lead tab 600 and have different polarities. The electrode leads 806 and 808 may be formed on one surface of the circuit board 802 in conductive layers.

The external terminals 810 are installed on the surface of the circuit board 802, which is opposite to the surface on which the electrode leads 806 and 808 are installed, and are electrically connected to the electrode leads 806 and 808. The external terminals 810 transfer current of a battery to the outside.

Since the battery pack 1000 contacts the battery cell 100 while biasing the battery cell 100 due to an elastic force of the first lead tab 400, the first lead tab 400 and the second lead tab 500 have excellent contact performance with respect to the battery cell 100.

In other words, the lead tabs and the protection circuit module are mechanically coupled to each other, thereby improving production and reliability of the battery cell 100.

Hereinafter, a process of forming the first lead tab 400 will be described. In the following description, the process of forming the first lead tab 400 will be described with regard to a case where the coupling unit 700 is a blind rivet 710 by way of example.

Referring to FIGS. 3A to 3C, the first lead tab 400 is plate-shaped and a length of the plate is longer than the bottom surface 302b of the upper case 300. The opposing sides 402 of the first lead tab 400 are attached to the opposing sides of the bottom surface 302b of the upper case 300. In addition, the opposing sides 402 of the first lead tab 400 are attached to the opposing sides of the bottom surface 302b of the upper case 300 such that the opposing sides 402 of the first lead tab 400 contact the inner side surfaces of the upper case 300, thereby increasing adhesion between the bottom surface 302b of the upper case 300 and the first lead tab 400.

As described above, since the first lead tab 400 is longer than the length of the bottom surface 302b of the upper case 300 and the opposing sides 402 of the first lead tab 400 are attached to the bottom surface 302b of the upper case 300, portions of the first lead tab 400, excluding the opposing sides 402 thereof, are arc-shaped and are spaced from the bottom surface 302b of the upper case 300.

The blind rivet 710 includes a head 711 and a body 712. A sectional area of the head 711 is larger than sectional areas of the first and second coupling holes 320 and 410. The body 712 is formed to generally correspond to the first and second coupling holes 320 and 410 but its sectional area is smaller than the sectional areas of the first and second coupling holes 320 and 410.

The body 712 of the blind rivet 710 penetrates, in order, the first coupling hole 320 and the second coupling hole 410 while the head 711 of the blind rivet 710 is positioned on the top surface 302a of the upper case 300 without penetrating the first coupling hole 320 or the second coupling hole 410.

A lower portion of the body 712 is compressed toward the bottom surface 302b of the upper case 300 by a separate device and a lower sectional area of the body 712 is increased. In other words, the sectional area of the lower portion of the body 712 becomes larger than sectional areas of the first and second coupling holes 320 and 410 when it compressed to thereby keep the rivet 710 in place (FIG. 3C). The lower portion of the body 712 pushes the central region 404 of the first lead tab 400 toward the bottom surface 302b of the upper case 300. In addition, when the first lead tab 400 is pushed toward the bottom surface 302b of the upper case 300 by the blind rivet 710, the protruding parts 330 formed at opposing sides of the first coupling hole 320 and the stamping part 420 formed in the first lead tab 400 serve as points of force and guides, thereby allowing the central region 404 of the first lead tab 400 to be easily bent. The opposing sides 402 and the central region 404 of the first lead tab 400 contact the bottom surface 302b of the upper case 300 and regions between the opposing sides 402 and the central region 404 of the first lead tab 400, that is, separating parts S1 and S2, are separated from the bottom surface 302b of the upper case 300. Thus, the first lead tab 400 is substantially ‘w’ shaped.

The coupling process including the third lead tab 600 can be fully understood from the above description.

The first lead tab 400 may be bent in a shape and then be coupled to the blind rivet 710.

While the present invention has shown that only the first lead tab 400 is modified by the coupling unit 700, the second lead tab 500 may also be modified by the coupling unit 700, thereby enhancing a contact force between the battery cell 100 and the first and second lead tabs 400 and 500.

While this invention has been described in connection with what is presently considered to be practical exemplary embodiments, it is to be understood that the invention is not limited to the disclosed embodiments, but, rather is intended to cover various modifications and equivalent arrangements included within the spirit and scope of the appended claims.

What is claimed is:

1. A battery pack comprising:
a battery cell;
a lower case having an opening and a space housing the battery cell;
an upper case coupled to the opening of the lower case and having a first coupling hole formed therein;
a first lead tab having opposing sides coupled to the upper case, a central region between the opposing sides contacting an interior-facing surface of the upper case and having a second coupling hole, and an intermediate region between each of the opposing sides and the central region, the intermediate region being spaced from the interior-facing surface of the upper case; and
a coupling unit coupling the first lead tab to the interior-facing surface of the upper case and penetrating the first coupling hole and the second coupling hole.

2. The battery pack of claim 1, further comprising a second lead tab contacting an end of the battery cell adjacent a surface of the lower case generally opposite to the opening and being exposed from the lower case.

3. The battery pack of claim 1, further comprising:
a third lead tab positioned on an exterior-facing surface of the upper case generally opposite to the interior facing surface and contacting the coupling unit; and
a protection circuit module coupled to the second lead tab and the third lead tab.

4. The battery pack of claim 3, wherein the third lead tab has a third coupling hole generally corresponding to the second coupling hole, and wherein the coupling unit penetrates the first coupling hole, the second coupling hole and the third coupling hole so that the central region of the first lead tab fixedly contacts the bottom surface of the upper case.

5. The battery pack of claim 3, wherein fixing holes are formed at opposing sides of the protection circuit module, and wherein the first lead tab and the second lead tab are coupled to the fixing holes.

6. The battery pack of claim 1, wherein the upper case includes a protruding part formed on the interior-facing surface with the first coupling hole located within a periphery of the protruding part.

7. The battery pack of claim 6, wherein the protruding part extends in a direction generally perpendicular to a lengthwise direction of the first lead tab.

8. The battery pack of claim 6, wherein the first lead tab includes a stamping part generally corresponding to the protruding part and being coupled to the protruding part.

9. The battery pack of claim 1, wherein the coupling unit comprises a blind rivet, a rivet, or a bolt and a nut.
